(19) United States
(12) Patent Application Publication
(10) Pub. No.: US 2012/0120654 A1
(43) Pub. Date: May 17, 2012

(54) LIGHTING APPLIANCE AND PROCESS FOR MANUFACTURING THE SAME

(76) Inventors: Shinobu Kobayashi, Tokyo (JP); Hiroaki Kawashima, Saitama (JP)

(21) Appl. No.: 13/266,290

(22) PCT Filed: Apr. 13, 2011
(86) PCT No.: PCT/JP2011/059667

§ 371 Date: Oct. 26, 2011

(30) Foreign Application Priority Data
May 28, 2010 (JP) 2010-123591

(51) Int. Cl. F21V 7/22; B29C 45/14

(52) U.S. Cl. 362/235; 264/272.14

(57) ABSTRACT

The object of the present invention is to provide lighting appliances of various shapes, which use light emitting diodes as a light source, having excellent light directivity, light-diffusing property, durability and shock-proof property.

The lighting appliance 1 according to the present invention is constituted by including a light illuminating member 13 formed by sealing off a substrate 8 mounted with light emitting diodes 81 therein with a synthetic resin material 9 prepared by mixing particulates 92 capable of diffusing light irradiated from the light emitting diodes 81 to the matrix substance 91.

### 1. FIELD OF INVENTION

The present invention relates to a lighting appliance and a process for manufacturing the same, particularly to a lighting appliance which employs a light emitting diode as the light source and has excellent light-diffusion property.

### 2. PRIOR ART

In the past, for interior lighting, and exterior lightings, particularly for lighting during construction works, a lighting appliance, like a socket 101 as shown in FIG. 21, comprising an electric light bulb with a filament (not shown) to be screwed into a socket body 102 connected to a cable 103 has been used for a long time. In recent years, however, light emitting diodes have been used as a light source for lighting appliances because of their durability and less energy consumption.

However, because of the property of light emitted by a light emitting diode irradiates one direction only, it has been difficult to provide lighting appliances which can satisfy appropriate light directivity and light-diffusing property.
[Patent Document 1] Japanese Unexamined Patent Application Publication No. 1994-163132
[Patent Document 2] Japanese Unexamined Patent Application Publication No. 2009-198597
[Patent Document 3] Japanese Unexamined Patent Application Publication No. 2009-181808
[Patent Document 4] Japanese Unexamined Patent Application Publication No. 2008-277116
[Patent Document 5] Japanese Unexamined Patent Application Publication No. 2003-303504
[Patent Document 6] Japanese Unexamined Patent Application Publication No. 2008-305837

### SUMMARY OF INVENTION

It is, therefore, an object of the present invention to provide a lighting appliance which employs light emitting diodes as its light source, wherein the light irradiated by a light emitting diode can give appropriate light directivity and light-diffusing property, and the lighting appliance can emit irradiation light in compliance with the target uses, and a process for manufacturing the lighting appliance.

In order to achieve the object described above, the lighting appliance according to the present invention is configured so that it is characterized in that light emitting diodes are mounted onto a substrate, and the lighting appliance includes a light illuminating member which is formed by sealing off said light emitting diodes therein with a synthetic resin material, to which light-diffusing particulates capable of diffusing light irradiated from the light emitting diodes are mixed.

The lighting appliance according to the present invention is further characterized in that the synthetic resin for sealing off the light emitting diodes is prepared by mixing particulates having a shape that causes Mie-diffusion against light irradiated from the light emitting diodes to a light-permeable synthetic resin matrix substance.

Said synthetic resin material for sealing off light emitting diodes is characterized by being prepared by mixing particulates of silicon dioxide to a light-permeable synthetic resin matrix substance.

Further, said synthetic resin used for sealing off light emitting diodes is characterized in that it is a synthetic resin material prepared by mixing agglomerates of particulates of highly-diffusible silica which is prepared by agglomerating and binding while melting silicon dioxide particulates to a light-permeable synthetic resin matrix substance.

The lighting appliance according to the present invention is further characterized in that said particulate of silicon dioxide has a spherical shape with a diameter of 10 to 30 nm, and said agglomerate of particulates of said high-diffusing silica is a bulky agglomerate, which has a diameter of from 100 to 400 nm and is formed as a result of agglomeration of plural particulates.

Further, the lighting appliance according to the present invention is further characterized in that the light-permeable matrix substance is a light-permeable silicon resin.

The lighting appliance according to the present invention is still further characterized in that the substrate mounted with light emitting diodes is connected with wires, and a light illuminating member is formed by sealing off said wires, said substrate and said light emitting diodes in one united body with a synthetic resin to which the particulates capable of diffusing light irradiated from light emitting diodes are mixed.

The lighting appliance according to the present invention is still further characterized in that said heat-discharging member is formed with a heat-conductive synthetic resin material and/or a metal member, and/or a heat-discharging ceramic material.

The lighting appliance according to the present invention is still further characterized in that said light illuminating member is formed in a spherical, hemisphere, flat plate, lens, or polygonal shape.

The lighting appliance according to the present invention is still further characterized in that the surface of the light illuminating member and cables extended from said light illuminating member are formed with a material inactive to explosive gasses so that the lighting appliance can be used as a lighting appliance capable of using in an explosion prevention area.

The process for manufacturing a lighting appliance according to the present invention is characterized by connecting wires to the substrate mounted with light emitting diodes, placing said substrate mounted with a light emitting diodes in a mold, and sealing off by molding said wires, said substrate and said light emitting diodes in one united body with a synthetic resin material to which particulates capable of diffusing light irradiated from said light emitting diodes are mixed to form a light illuminating member. The process for manufacturing a lighting appliance according to the present invention is further characterized by connecting wires to the substrate mounted with light emitting diodes, placing said substrate mounted with light emitting diodes and a heat-discharging member in a mold, and sealing off by molding said wires, said substrate, said light emitting diodes and said heat-discharging member in one united body with a synthetic resin material to which particulates capable of diffusing light irradiated from said light emitting diodes are mixed to form a light illuminating member.

In the lighting appliance according to the present invention, it is so configured that light emitting diodes are mounted onto a substrate, and a light illuminating member is formed by sealing off said light emitting diodes with a synthetic resin material to which light-diffusing particulates capable of diffusing light irradiated from said light emitting diodes. With such a configuration, it is made possible to provide a lighting appliance with excellent light directivity and light-diffusing property.

The synthetic resin material used for sealing off the light emitting diodes is prepared by mixing particulates each having a shape capable of causing Mie-diffusion against light irradiated from the light emitting diodes to a light-permeable synthetic resin matrix substance. By using this synthetic resin material explained hereinabove, it is enabled to provide a lighting appliance, wherein a wide area of a light illuminating member can be lightened and excellent light directivity and light-diffusing property of the lighting appliance may be secured.

Further, the synthetic resin material used for sealing off the light emitting diodes is prepared by mixing particulates of silicon dioxide to a light-permeable synthetic resin matrix substance. By using this synthetic resin material explained hereinabove, it is enabled to provide a lighting appliance, wherein a wide area of a light illuminating member, including the opposite side to the side whereto the light emitting diodes have been mounted, can be lightened and excellent light directivity and light-diffusing property of the lighting appliance may be secured.

Yet, the synthetic resin material used for sealing off said light emitting diodes is a synthetic resin material prepared by mixing agglomerates of particulates highly-diffusible silica particulates prepared by agglomerating and binding while melting the particulates of silicon dioxide to a light-permeable synthetic resin matrix substance. By using this synthetic resin material explained hereinabove, secured light diffusion from the light illuminating member can be achieved.

Since said particulate of silicon dioxide is a spherical particle with a diameter of from 10 to 30 nm, and these particulates agglomerated to result in said agglomerates of said highly-diffusible silica particulates each having a diameter of from 100 to 400 nm, which is a bulky agglomerate. Because of such a structure of the agglomerate of the highly-diffusible silica particulates, light diffusion in the light illuminating member can be securely caused.

In addition, since the light-permeable matrix substance is a light-permeable silicon resin, it has good compatibility with the particulates and gives good diffusion of the particulates. Especially, when highly-diffusible silica is used and mixed as said particulates, homogeneous diffusion of the particulates can be obtained and provision of a lighting appliance provided with excellent shockproof can be achieved.

Further, in the lighting appliance according to the present invention, the substrate mounted with a light emitting diodes is connected with wires, and said wires, said substrate and said light emitting diodes are sealed off by molding in one united body with a synthetic resin material, to which particulates capable of diffusing light irradiated from the light emitting diodes. Since the lighting appliance of the invention is constituted as described above, it can be provided as a lighting appliance which has excellent waterproof, dustproof, shockproof and anti-pressure properties.

Further, since said substrate is jointed with a heat-discharging member, heat can be discharged even though the light emitting diodes, the substrate, and/or the other sections in a circuit generate heat, which prevents the parts from being damaged due to heat.

Further, since said heat-discharging member is composed of a heat-conductive synthetic resin and/or a metal member and/or a heat-discharging ceramic, the heat-discharge can be effected with a relatively low cost, when a heat-conductive synthetic resin material or a metal member is used as the heat-discharging member. Besides, a ceramic material can be used as the heat-discharging member as well, and it is installed at any part, since it converts heat to far infrared radiation to thereby discharge heat.

According to the process for manufacturing a lighting appliance according to the present invention, wherein a substrate mounted with light emitting diodes is connected with wires, the substrate mounted with said light emitting diodes is placed in a mold, and said wires, said substrate and said light emitting diode are sealed off by molding in one united body with a synthetic resin material to which particulates capable of diffusing light irradiated from the light emitting diodes, a lighting appliance which has excellent light directivity and light-diffusing property can be produced easily, and a lighting appliance, the parts of which are not exposed, and is provided with excellent waterproof, dustproof, shockproof and pressure-resistant properties can be produced. Furthermore, if the heat-discharging member is also molded integrally, the lighting appliance will not be broken due to heat even though any part of the lighting appliance happens to generate heat.

### BRIEF DESCRIPTION OF THE DRAWING

FIG. 1 A side view of a lighting appliance of the hemispherical type according to the first embodiment of the present invention, wherein the part thereof is shown with a cross-sectional view taken along A-A line.

FIG. 2 A plan view of a heat-discharging plate used for the lighting appliance shown in FIG. 1.

FIG. 3 A schematic enlarged view of a part of the light illuminating member of the lighting appliance shown in FIG. 1.

FIG. 4 A side view of the lighting appliance of the spherical type according to the second embodiment of the present invention.

FIG. 5 A cross-sectional view taken along A-A line of the lighting appliance shown in FIG. 4.

FIG. 6 A cross-sectional view of a spherically-shaped lighting appliance according to the third embodiment of the present invention.

FIG. 7 A cross-sectional view taken along B-B line of the lighting appliance shown in FIG. 6.

FIG. 8 A side view of the lighting appliance of the spherical type according to the fourth embodiment of the present invention.

FIG. 9 A side view of the lighting appliance shown in FIG. 8, wherein the part thereof is shown in a cross-sectional view taken along A-A line.

FIG. 10 A cross-sectional side view taken in the vertical direction of a lighting appliance of the spherical type according to the fifth embodiment of the present invention.

FIG. 11 A cross-sectional view from the lateral direction of the lighting appliance shown in FIG. 10.

FIG. 12 A cross-sectional view in the vertical direction of a variation of the lighting appliance of the spherical type according to the fifth embodiment of the present invention.

FIG. 13 A perspective view of the lighting appliance of the plate type according to the sixth embodiment of the present invention.

FIG. 14 A cross-sectional view in the vertical direction of the plate-type lighting appliance shown in FIG. 10.

FIG. 15 A side view of a disc-shaped lighting appliance of the attached-to-ceiling type according to the seventh embodiment of the present invention, wherein the part thereof is shown in the cross-sectional view.

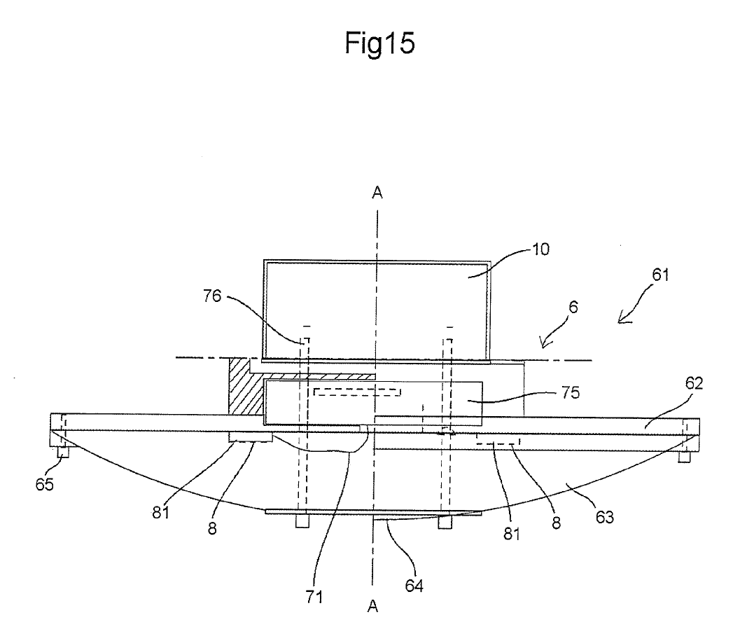

FIG. 16 A plan view of the lighting appliance shown in FIG. 12.

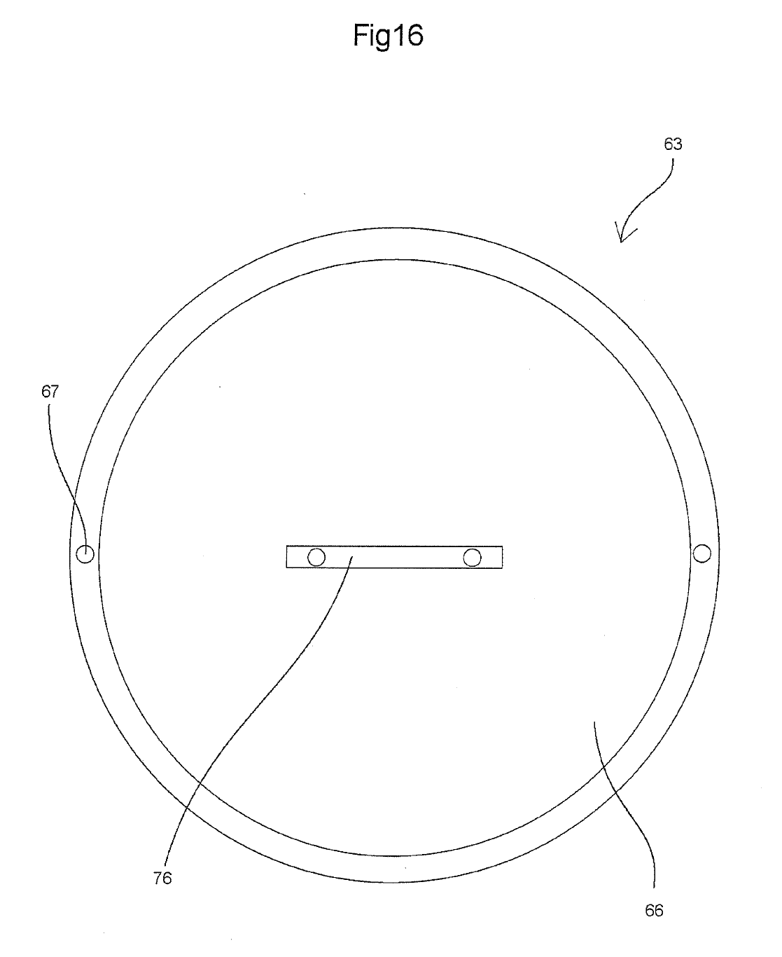

FIG. 17 A plan view of a power source box of the lighting appliance shown in FIG. 12.

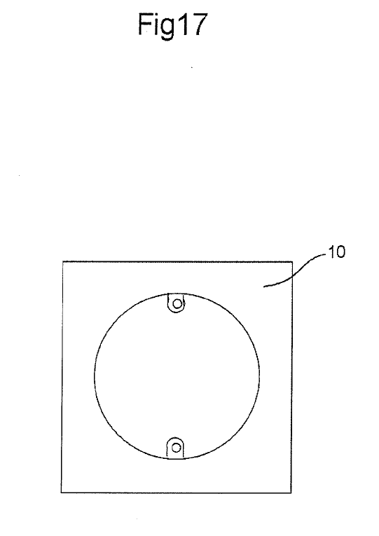

FIG. 18 A side view of a plate-shaped lighting appliance of the attached-to-ceiling type according to the eighth embodiment of the present invention, wherein the part thereof is shown in the cross-sectional view.

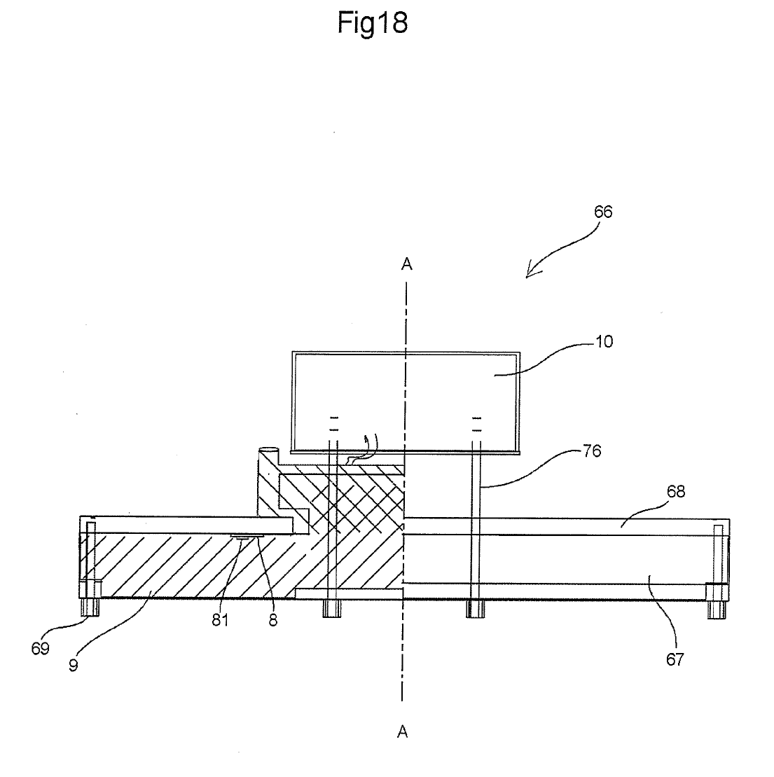

FIG. 19 A plan view from the back side of the lighting appliance shown in FIG. 14.

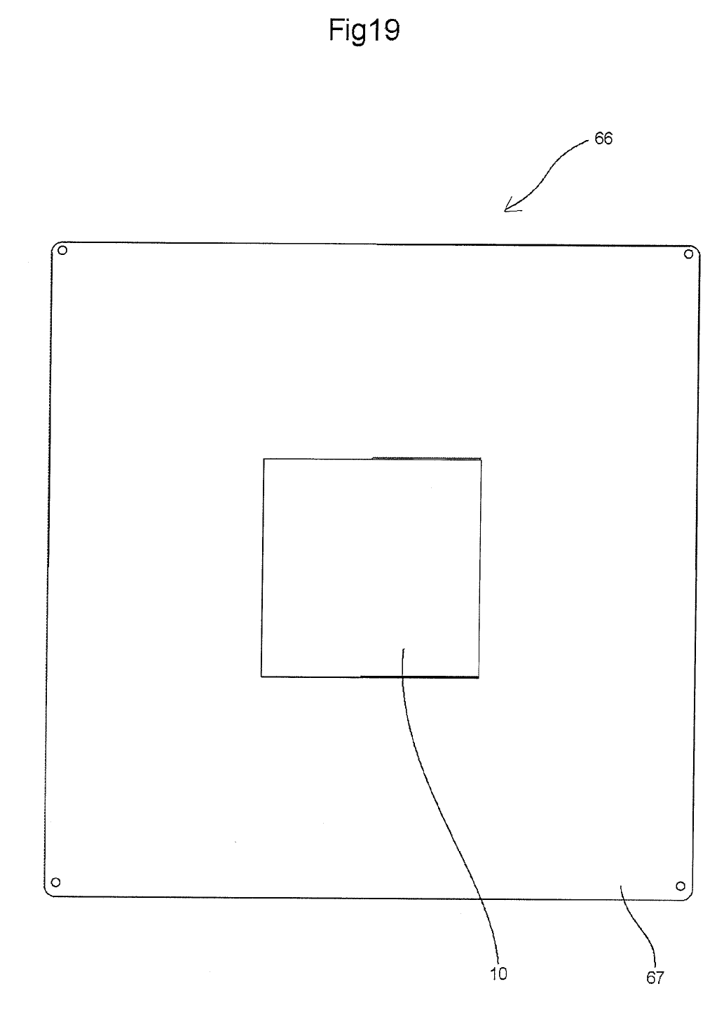

FIG. 20 A plan view from the front side of the lighting appliance shown in FIG. 14.

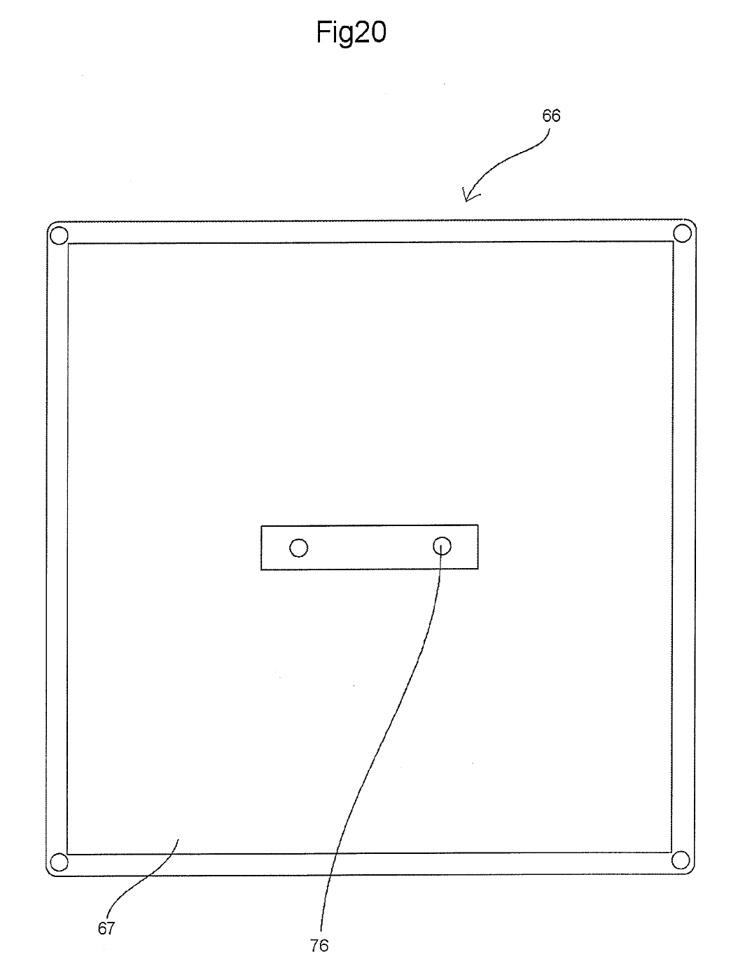

FIG. 21 A side view of a conventional socket used for a lighting appliance.

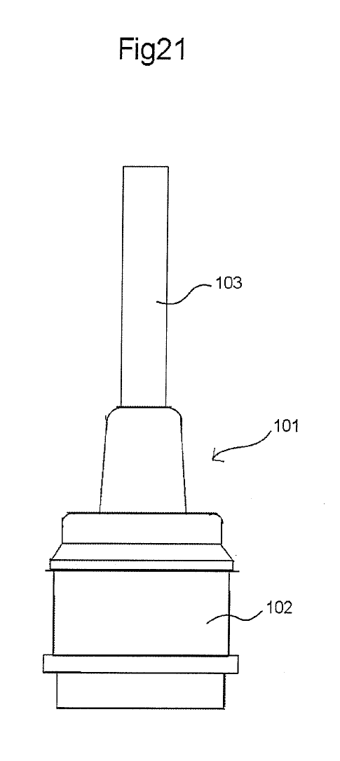

### DETAILED DESCRIPTION OF THE PREFERRED EMBODIMENTS

### First Embodiment

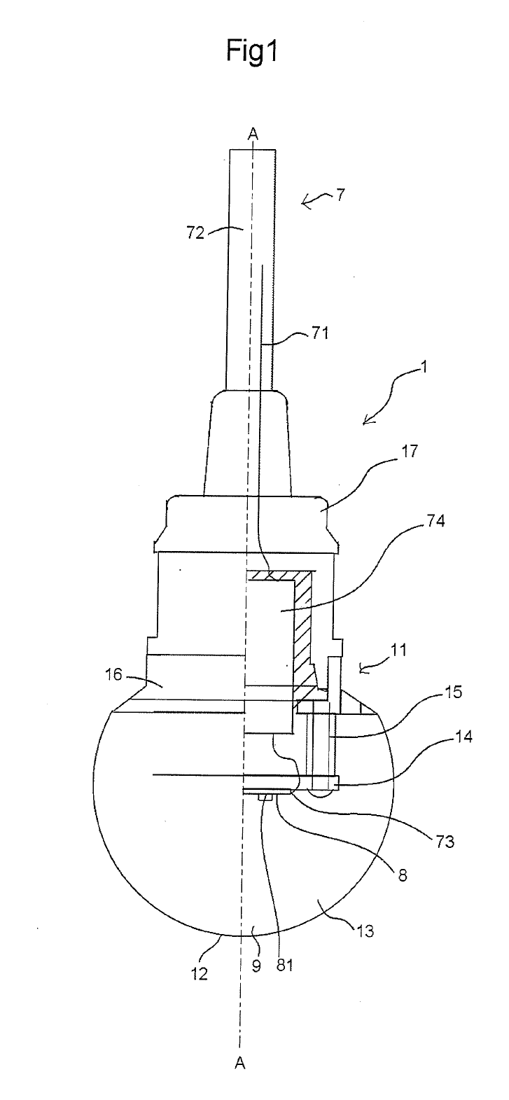

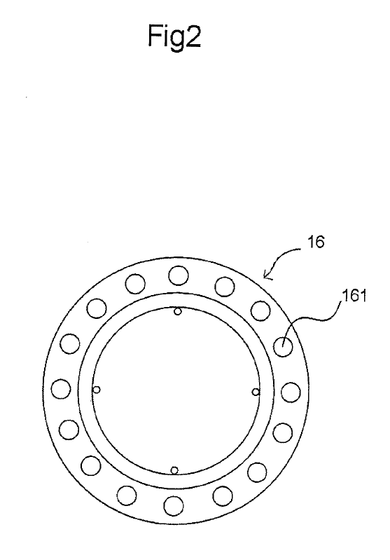

The lighting appliance according to the first embodiment of the present invention is shown in FIGS. 1 and 2. The lighting appliance according to the first embodiment includes light emitting diodes 81 as a light emitting element and a lighting appliance main body 11 including a light illuminating member 13 which seals off said light emitting diodes, and the lighting appliance main body 11 is connected with a cable 7. The lighting appliance main body 11 includes a substrate 8 mounted with light emitting diodes 81, wires 71 to be connected with the substrate 8, and a light illuminating member 13 formed with a synthetic resin material 9 mixed with light-diffusing particulates, said synthetic resin material seals off them in one united body to form the light illuminating member.

Specifically, a plurality of light emitting diodes 81 are mounted to the front surface of the substrate 8, and a pair of wires 71 are connected to the substrate 8 in order to cause said light emitting diodes 81 on the substrate 8 to emit light. The wire 71 extends from the position of the substrate to the rear end side (the cable 7 side) of the lighting appliance via a control unit 74 comprising a setting 14 for supporting the substrate 8, an AC adaptor unit, a rated current control board, etc., and is connected to a power source (not shown) via a main cable (not shown) and a rectifier (not shown).

The setting 14 to which the substrate 8 is arranged is jointed to a connecting tube 15, and the connecting tube 15 is connected to a disc-shaped heat-discharging plate 16 to be arranged in between a reinforcing cylinder 17 shown in FIG. 2 and the light illuminating member 13. At the disc periphery of the disc-shaped heat-discharging plate 16, a heat-discharging pore 161 is opened. The setting 14, the connecting tube 15 and the heat-discharging plate 16 are all made of a heat-conductive metal material, such as aluminum, and the setting 14 and the connecting tube 15 are adapted to transmit heat generated on the substrate 8 to the heat-discharging plate 16 to thereby discharge heat.

Further, the substrate 8, the light emitting diodes 81 mounted on the substrate 8, and the joint point 73 of the wires 71 to the substrate and the vicinity thereof are sealed off in one united body with a synthetic resin material 9 mixed with highly-diffusible silica described later, by means of a molding technique to thereby form a light illuminating member 13.

According to the first embodiment shown in FIG. 1, said synthetic resin material 9 is formed in a hemispherical shape so as to face the front end 12 of the light illuminating member 13, and the rear portion of said synthetic resin material is formed in a cylindrical shape. And, the outer circumferential portion of the cylindrical portion is covered with a reinforcing cylinder 17 that forms an outer shell so that the control unit 74 is surrounded by the reinforcing cylinder. And, this hemispherical member as a whole comprises a light illuminating member 13. Note that the synthetic resin material 9 is fixed to said cable 7 so that the point section of the cable 7 is sealed off by the synthetic resin material at the rear end side of the synthetic resin material 9.

As described above, the cable 7 is formed in such a state that it is covered with an insulating member 72 at a part of the wire 71, from which part the wire 71 extends from the light illuminating member, and which is connected to the substrate 8 mounted with light emitting diodes 81 via an AC adaptor and a control unit 74. Further, the rear end part (not shown) of the cable 7 is connected to a main cable (not shown) which establishes a connection from a branched part (not shown) of the cable to the power source (not shown), and the main cable may be connected with a plurality of lighting appliances 1 via a plurality of cables 7 if required.

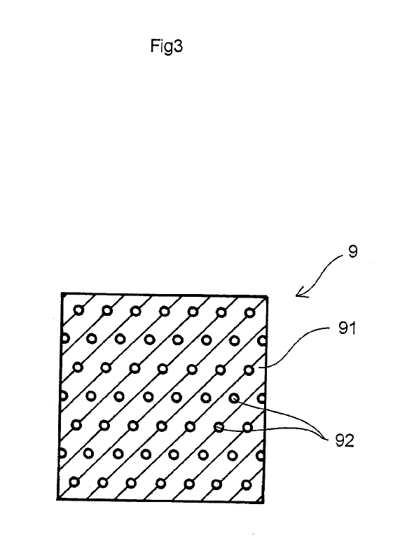

Now, the synthetic resin material 9 to be used for forming the light illuminating member 13 according to the first embodiment will be explained. As shown in the schematic view of FIG. 3, the synthetic resin material 9 is a light-permeable synthetic resin, which is prepared by firstly forming the matrix portion 91 using a silicon resin having a certain elasticity as the matrix substance, then mixing particles 92 of highly-diffusible silica as light-diffusion particulates to the matrix portion 91, and which can resist heat generated from the light emitting diodes 81 and the substrate 8. As shown in said schematic view, the agglomerates of particles of the highly-diffusible silica are substantially-homogeneously distributed in the silicon resin as the matrix substance, irrespective of the positions in the cross sections taken at different positions of the light illuminating member. The highly-diffusible silica is generally called as dried silica or fumed silica, and it is produced by means of combustion hydrolysis of silicon tetrachloride. More specifically, silicon dioxide obtained according to the combustion method exists in the form of a spherical particle with a diameter of from 10 to 30 nm in the air, and the plural particles thereof may result in an agglomerate and bind with each other to form a bulky agglomerate with a diameter of from 100 to 400 nm, which comprises said highly-diffusible silica.

Note that the particles which cause the light illuminating member 13 to irradiate light to the entire direction, including the portion in the front side of the light emitting diode 81 but also the portion at the reverse side to the light emitting diodes 81 in milky color is not limited to the highly-diffusible silica, and any particles may be used as far as the size of the particles and the wavelength of the irradiated light are the same or more to/than those of said highly-diffusible silica and the particles may cause Mie-diffusion. Note that occurrence of Mie-diffusion depends on the size of the particulates and the complex refractive index, those which are represented by the following equation.

$$\begin{matrix}{Q}_{ext} = 2 / {x}^{2} {\sum }_{n = 1}^{∞} ( 2 n + 1 ) Re ( {a}_{n} + {b}_{n} ) & [ Equation 1 ] \\ x = 2 π r / λ & [ Equation 2 ]\end{matrix}$$

As described above, the addition of such a highly-diffusible silica, to a matrix substance, such as silicon, can bring various effects. In view of the irradiated light from the light illuminating member formed by using the synthetic resin material 9 comprising a silicon matrix to which said highly-diffusible silica is mixed, light irradiated from the light emitting diodes collides against the highly-diffusible silica to cause Mie-diffusion to thereby produce soft light in milky color around the whole area of the light illuminating member, which has good light permeability, light directivity and light-diffusing property, and cause no local dazzle contrary to the conventional lighting appliances of this type. In case of the lighting appliance main body 11 shown in FIG. 1, a substrate 8 and light emitting diodes 81 are placed at the center of the light illuminating member 13 composed of the synthetic resin material 9, homogeneous light irradiation is obtainable in substantially the whole area of the hemispherical body, which makes feasible to provide a lighting appliance with a wide light irradiation view. Further, by adjusting the particulate size of the highly-diffusible silica, in particular by increasing the particulate size, for example, light directivity toward the front side of the substrate can be strengthened, and appropriate directivity and diffusion property corresponding to the use and the place where it is used can be secured.

In a physical point of view, the light illuminating member comprising the silicon resin mixed with the highly-diffusible silica is provided with appropriate elasticity, which improves the shockproof property of the light illuminating member. Further, improvement of the surface property, such as prevention of occurrence of a sticky surface may be brought by the addition of the highly-diffusible silica to the silicon resin, and holding of the shape at the time of molding, such as injection molding and extrusion molding, during the manufacturing process of the lighting appliance can be secured.

### Second Embodiment

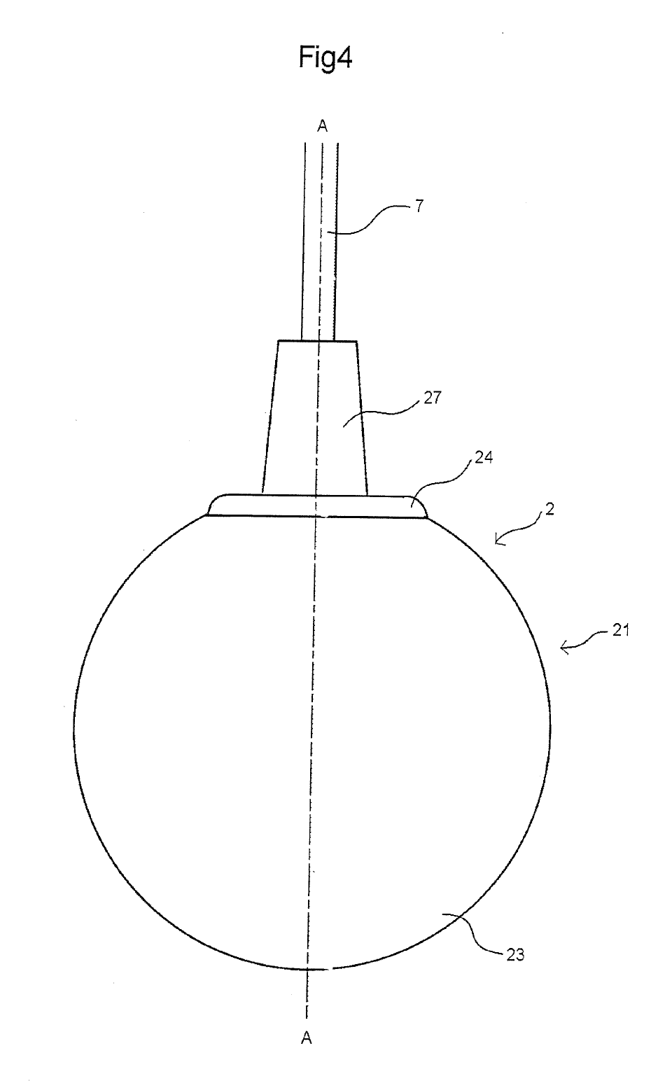

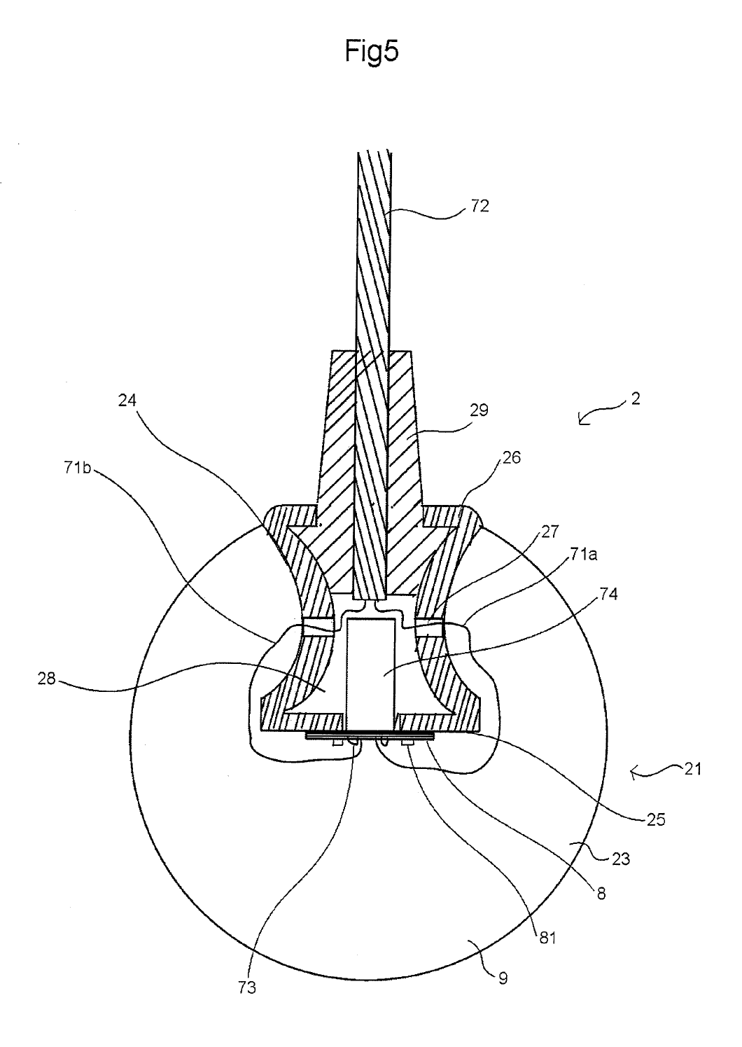

FIG. 4 is a side view of the lighting appliance according to the second embodiment of the present invention, and FIG. 5 is a cross-sectional view taken along A-A line of the lighting appliance shown in FIG. 4. The lighting appliance 2 according to the second embodiment also includes a lighting appliance main body 21, in which light emitting diodes 81 as a light emitting element and a light illuminating member 23 which seals off said light emitting diodes are included, and a cable 7 is connected with the lighting appliance main body 21. The light illuminating member 23 is formed with a synthetic resin material 9 which is used to seal off the substrate 8 to which a light emitting diode 81 is mounted, and the synthetic resin material 9 is prepared by mixing highly-diffusible silica as the light-diffusible particles to a light-permeable silicon resin having a certain elasticity, similarly to the first embodiment.

Specifically, a plurality of light emitting diodes 81 are mounted to the front side of the substrate 8, and a pair of wires 71a, 71b are connected to the substrate 8 so that the light emitting diodes 81 mounted on the substrate 8 emit light. The wire 71 extends from a position of the substrate to a rear end side (cable 7 side) of the lighting appliance through an AC adaptor unit surrounded by a heat-discharging member 24 to support the substrate 8 and a control unit 74 comprising a rated current control board, etc., and is further connected to the power source (not shown) through a main cable (not shown), a rectifier (not shown) and the like.

The heat-discharging member 24 for supporting the substrate 8 is consisted of a ceramic material which converts heat to far infrared radiation to thereby discharge it in the form of electromagnetic waves, and is shaped in a bobbin form which includes a hollow 28 therein. A substrate 8 is arranged to the front end surface 25 of the bobbin-shaped heat-discharging member 24, and the rear end surface 26 is jointed to the outer side of a reinforcing cylinder 29 adapted to reinforce the connecting section of the cable 7 and the light illuminating member 23.

Further, by selecting the diameter of the rear end surface 26 properly, the rear end surface 26 works as an irradiation angle control board for blocking light irradiated from the light illuminating member 23, which has a light irradiation angle of 360 degree as described later, to thereby limit light irradiation angle. Still further, a control unit 74 is provided to the hollow section of the heat-discharging member 24, and it is configured that the wire 71 extending from the control unit 74 through an insert pore 27 formed in the ventral part of the heat-discharging member is guided to the front end surface 25 of the heat-discharging member 24 and is connected to the substrate 8.

The heat-discharging member 24, the hollow section 28, the substrate 8 and the light emitting diodes 81 mounted on the substrate 8, the substrate joint point 73 of the wire 71, and the vicinity thereof are sealed off in one united body with the synthetic resin material 9 mixed with the highly-diffusible silica to form the light illuminating member 23. The synthetic resin material 9 is also filled into the hollow section 28 of the heat-discharging member 24 so that the cable 7, the control unit and the light illuminating member 23 are firmly fixed in one united body.

In the second embodiment shown in FIG. 4 and FIG. 5, the light illuminating member 23 is formed in substantially a spherical shape, a substrate 8 to the center of which light emitting diodes 81 are mounted is arranged, and a wire 71 to be connected to the substrate 8 is fixed at the joint point to the substrate 8 and the vicinity thereof using the synthetic resin material 9 and is extended to the power source (not shown).

Regarding the synthetic resin material 9, it is prepared by distributing the agglomerates of highly-diffusible silica particulates homogeneously irrespective of the location inside the light illuminating member to a silicon resin as the matrix substance. Then, the particulates 92 of highly-diffusible silica being homogeneously distributed diffuse light irradiated from the light emitting diodes to thereby cause Mie-diffusion. In the second embodiment, the whole periphery of the spherical light illuminating member can be a light illuminating member. Therefore, substantially 360 degrees of light irradiation view can be secured, and it will be so advantageous in terms of safety for pedestrians when it is set on a road at a construction site. Because the synthetic resin material 9 mixed with highly-diffusible silica has a certain elasticity, there would be no case that the light illuminating member is broken or damaged by external shock and the like.

Since the composition of the synthetic resin material 9 in this embodiment is the same as that described in the first embodiment, and therefore, the detail thereof shall be omitted. Note that the mixing ratio for the matrix substance 91 and the particulates 92 of highly-diffusible silica is determined in accordance with the size and shape of the light illuminating member 23. In general, the more the size of the light illuminating member 23 increases, the more the ratio of the particulates 92 of highly-diffusible silica decreases, and vice versa.

### Third Embodiment

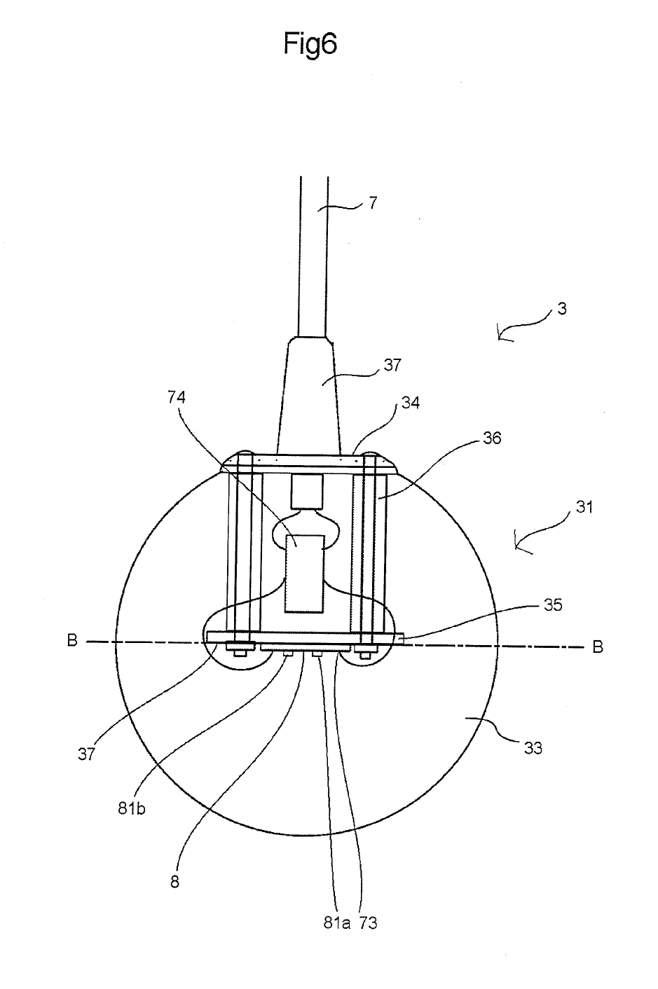

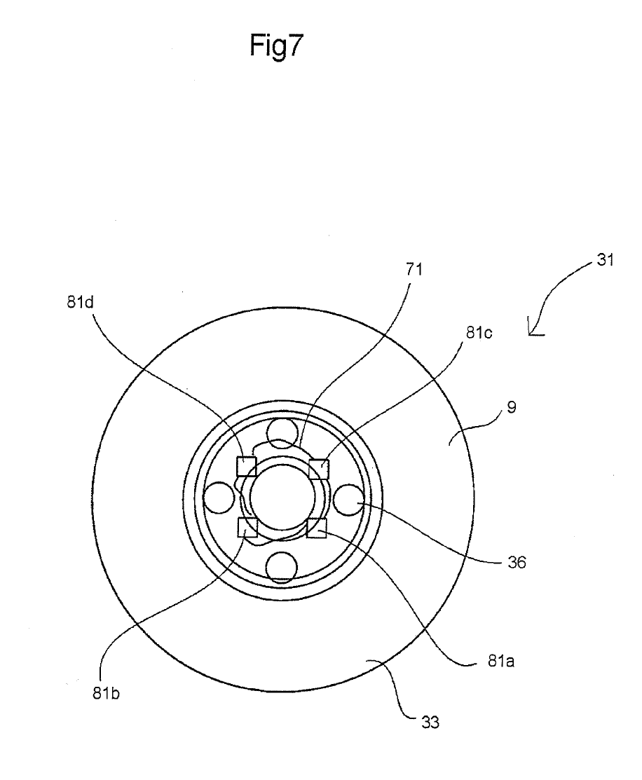

In FIG. 6 and FIG. 7, a variation of the spherical lighting appliance according to the third embodiment is shown. FIG. 6 is a cross-sectional view of the lighting appliance according to the third embodiment taken in the vertical direction, and FIG. 7 is a cross-sectional view of the lighting appliance shown in FIG. 6 taken along B-B line.

The lighting appliance 3 according to the third embodiment also includes a lighting appliance main body 31 in which light emitting diodes 81 as a light emitting element and a light illuminating member 23 to seal off the light emitting diodes are included, and a cable 7 is connected to the lighting appliance main body 31. Further, the light illuminating member 33 is formed with a synthetic resin material 9 which seals off a substrate 8 mounted with light emitting diodes 81. The synthetic resin material 9 is prepared, similarly to the first embodiment, by mixing highly-diffusible silica as light-diffusing particulates to a light-permeable silicon resin having a certain elasticity.

Specifically, a plurality of light emitting diodes 81 are mounted to the front surface of the substrate 8, and a pair of wires 71a, 71b are connected to the substrate 8 so that the light emitting diodes emit light. The wire 71 extend from the position of the substrate 8 to the rear end side (cable 7 side) of the lighting appliance through a control unit 74, and are connected to the power source (not shown) through a main cable (not shown) and a rectifier (not shown).

And, the heat-discharging mechanism that supports the substrate is constituted with an aluminum bottom plate 35, aluminum heat-conductive tubes 36, and a ceramic heat-discharging plate 34, the aluminum bottom plate 35 to which the substrate 8 is arranged is contacted to the cylindrical aluminum heat-conductive tubes 36, and the aluminum heat-conductive tubes are connected to the disc-shaped ceramic heat-discharging plate 34 which is arranged between a reinforce member 37 and the light illuminating member 33. The disc-shaped ceramic heat-discharging plate 34 is made of a ceramic material which converts heat to far infrared radiation to discharge heat in the form of electromagnetic waves, and the aluminum bottom plate 35 and the aluminum heat-conductive tubes 36 are adapted to transmit heat appeared from the substrate 8 to the ceramic heat-discharging plate 34 to thereby discharge heat.

Further, the ceramic heat-discharging plate 34 works as an irradiation angle adjustment board for the light illuminating member 33 which has an irradiation angle of 360 degrees as described later by properly selecting the diameter of the ceramic heat-discharging plate 34. Further, the control unit 74 is arranged in the central part where the cylindrical aluminum heat-conductive tubes 36 are arranged in the standing state, and the wires 71 extended from the control unit 74 is adapted to be guided to the front surface of the aluminum bottom plate 35 and connected to the substrate 8.

The ceramic heat-discharging plate 34, the aluminum bottom plate 35, the cylindrical aluminum heat-conductive tubes 36, the control unit 74, the substrate 8 and light emitting diodes 81 mounted to said substrate 8, the joint points 73 of the wires 71 to the substrate, the inner side of the aluminum heat-conductive tubes 36 and the vicinity thereof are sealed off with a synthetic resin material 9 which is mixed with highly-diffusible silica in one united body so that the light illuminating member 33 is formed.

In the third embodiment shown in FIG. 6 and FIG. 7, a light illuminating member 33 is formed in substantially a spherical shape, and a substrate 8 mounted with light emitting diodes is arranged at the center of the light illuminating member. Wires 71 to be connected to the substrate 8 are fixed with the synthetic resin at the connection parts with the substrate 8 and the vicinity and further extended to the power source (not shown).

The synthetic resin material 9 in this embodiment is also prepared by homogeneously dispersing the particulates of highly-diffusible silica to a silicon resin as the matrix substance irrespective of the locations across the light illuminating member. Then, Mie-diffusion is caused when light irradiated from the light emitting diodes collides against the particulates 92 of highly-diffusible silica. In the third embodiment, since the whole periphery of the spherical light illuminating member 33 works for light illumination, a light illumination view over a range of substantially 360 degrees can be secured, and therefore, it may be so advantageous when it is set on a road in a construction site in view of safety for pedestrians. Since the synthetic resin material mixed with the highly-diffusible silica has a certain elasticity, it would never be broken or damaged due to shocks imposed from the outside.

The composition of the synthetic resin material 9 in this embodiment is the same as that in the first embodiment, and therefore, an explanation on the detail thereof shall be omitted. Note that the mixing ratio of the matrix substance 91 and the highly-diffusible silica particulates 92 will be determined depending on the size and shape of the light illuminating member 33. In general, the more the size of the light illumination member 23 increases, the more the ratio of the particulates 92 of highly-diffusible silica decreases, and vice versa.

### Fourth Embodiment

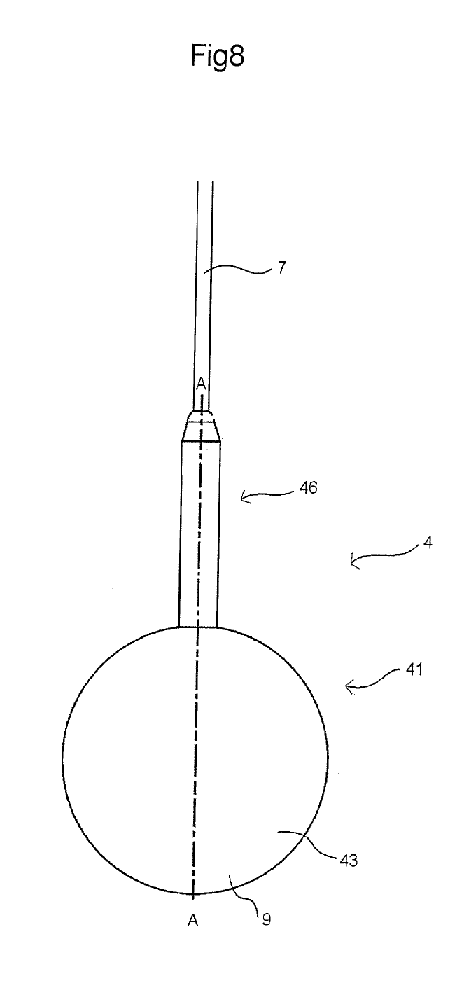

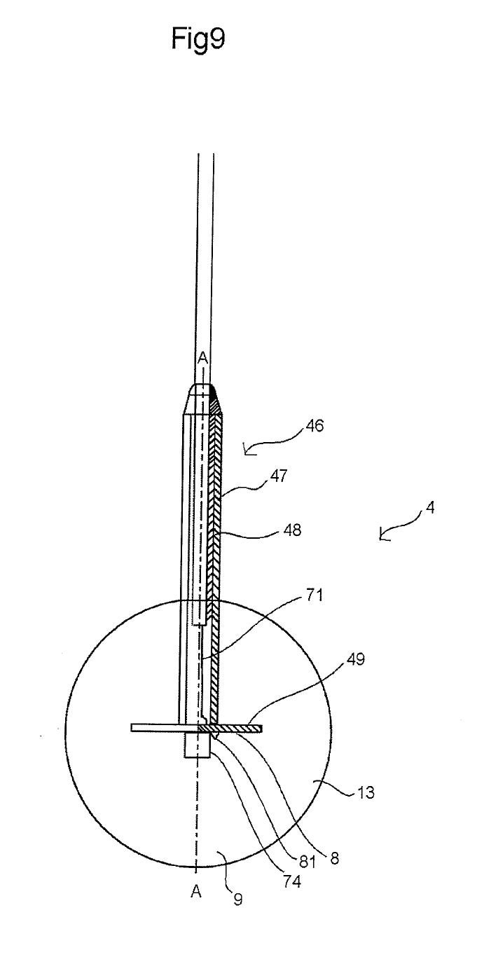

Referring to FIG. 8 and FIG. 9, a variation of the lighting appliance of the spherical type according to the fourth embodiment is shown. FIG. 8 is a side view of a lighting appliance according to the fourth embodiment of the present invention. FIG. 9 is a side view of the lighting appliance shown in FIG. 8, the part of which is shown in a cross-sectional view taken along A-A line.

A lighting appliance according to the fourth embodiment includes a lighting appliance main body 41 in which light emitting diodes 81 as a light emitting element and a light illuminating member 43 to seal off the light emitting diodes are included, and a cable 7 is connected to the lighting appliance main body 41. The light illuminating member 43 is formed with a synthetic resin material 9 which seals off a substrate 8 mounted with the light emitting diodes 81. Similarly to the first embodiment, the synthetic resin material 9 used in this embodiment is prepared by mixing highly-diffusible silica as light-diffusing particulates to a light-permeable silicon resin having a certain elasticity.

The lighting appliance main body 41 includes a light illuminating member 43 composed of a synthetic resin material 9 which seals off light emitting diodes 81 mounted on a substrate 8 and wires 71 to be connected to the substrate 8 in one united body therein.

Specifically, a plurality of light emitting diodes 81 are mounted to the substrate 8, and a pair of wires 71a, 71b are connected to the substrate 8 so that those light emitting diodes mounted on the substrate 8 emit light. The wires 71 extend from the position of the substrate to the rear end side (cable 7 side) through a control unit 74 to support the substrate 8 and a ceramic heat-discharging rod 46 and is connected to the power source (not shown) via a main cable (not shown), a rectifier (not shown), and so on.

The ceramic heat-discharging rod 46, to which the substrate 8 is arranged, comprises a ceramic tube 47, a metal heat-conductive bar 48 contained in the ceramic tube 47 and having heat-conductive property and a setting 49, said setting 49 and said heat-conductive bar 48 transmits heat appeared from the substrate 8 to the ceramic tube 47, and the ceramic tube is adapted to convert heat to far infrared radiation to thereby discharge heat in the form of electromagnetic waves. Note that a control unit 74 is arranged to the front end surface of the setting 49.

The ceramic heat-discharging rod 46, the substrate 8 and light emitting diodes mounted on the substrate 8, the joint points of the wires 71 and the substrate, and the vicinity thereof are sealed off with the synthetic resin material 9 in one united body so that the light illuminating member 43 is formed.

In the fourth embodiment shown in FIG. 8 and FIG. 9, the light illuminating member 43 is formed in substantially a spherical shape, the substrate 8 mounted with light emitting diodes 81 is arranged at substantially the center of the light illuminating member, and the wires 71 to be connected to the substrate 8 are fixed at the joint points to the substrate and the vicinity thereof and pass straightly through the inside of the ceramic heat-discharging rod to extend to the power source side (nit shown).

The synthetic resin material 9 is prepared by homogeneously distributing particulates of highly-diffusible silica throughout a silicon resin as the matrix substance. Then, light irradiated from the light emitting diodes collides against the particulates 92 of highly-diffusible silica to cause Mie-diffusion. In the fourth embodiment, since the whole periphery of the spherical light illuminating member 43 works as a light illumination member, a light irradiation range of substantially 360 degrees can be secured, and therefore, the use of the lighting appliance according to this embodiment is so advantageous when it is used on a road where construction work had been carried out in view of safety for the pedestrians. Since the synthetic resin material mixed with said highly-diffusible silica has a certain elasticity, it would never be broken or damaged due to shocks imposed from the outside.

Since the composition of the synthetic resin material 9 in this embodiment is the same as that in the first embodiment, an explanation on the detail thereof shall be omitted. Note that the mixing ratio of the matrix substance 91 and particulates of highly-diffusible silica is determined depending on the size and shape of the light illuminating member 43. Generally, the more the size of the light illuminating member 43 increases, the more the ratio of the particulates 92 of highly-diffusible silica decreases, and vice versa.

### Fifth Embodiment

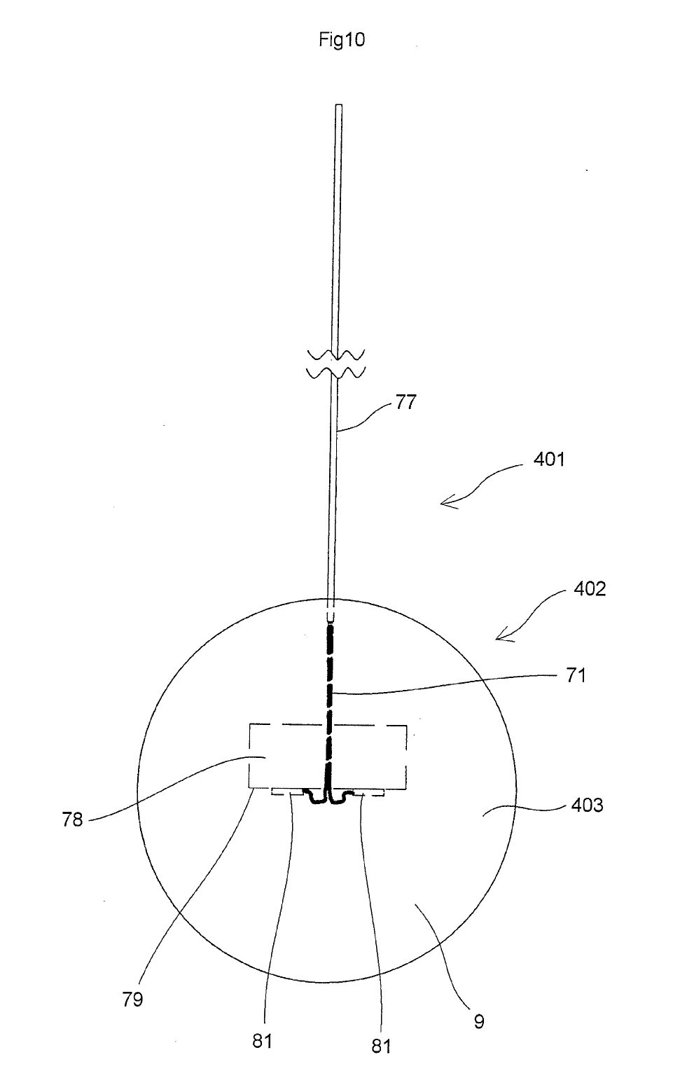

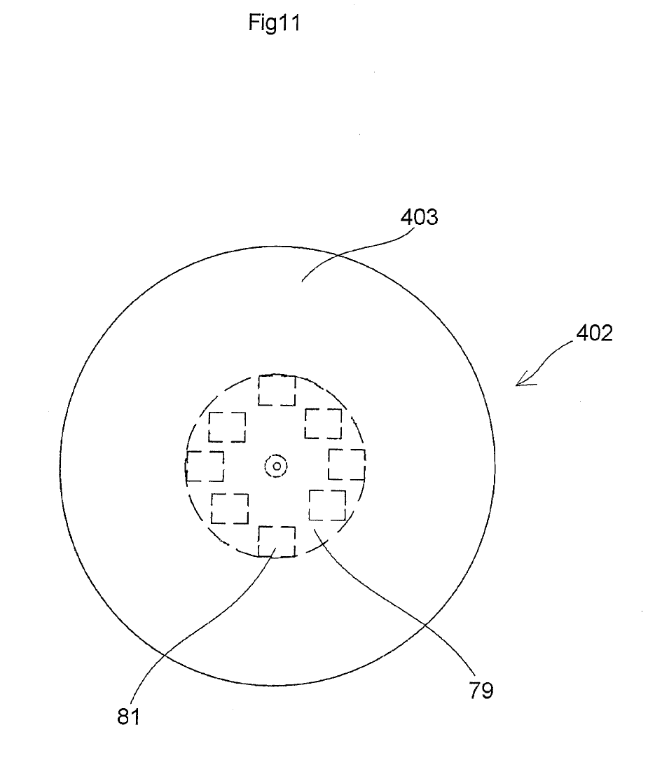

Referring to FIG. 10 and FIG. 11, a variation of the lighting appliance of the spherical type according to the fifth embodiment of the present invention is shown. FIG. 10 is a cross-sectional view of the lighting appliance 401 according to the fifth embodiment of the present invention taken in the vertical direction, and FIG. 11 is a cross-sectional view of said lighting appliance taken in the transverse direction.

A lighting appliance 401 according to the fifth embodiment includes a lighting appliance main body 402 in which light emitting diodes 81 as a light emitting element and a light illuminating member 403 to seal off the light emitting diodes therein are included, and a cable 77 is connected to the lighting appliance main body 402. Referring to the light illuminating member 403, one end surface 79 of a ceramic heat-discharging member 78 also works as a substrate, and the light illumination member 403 is formed with a synthetic resin material 9, which seals off light emitting diodes 81 mounted on said one end surface 79. The synthetic resin material 9 used in this embodiment is prepared by mixing highly-diffusible silica as light-diffusing particulates to a light-permeable silicon resin having a certain elasticity, similarly to the first embodiment.

The ceramic heat-discharging member is formed in a box shape and is made of a ceramic material, and the peripheral surface thereof is adapted to be used as a substrate. Namely, because the ceramic material is an insulating material, the peripheral surface of the ceramic heat-discharging member may also be used as a substrate, and light emitting diodes can be mounted directly to the peripheral surface. In this embodiment, a circuit is printed to the one end surface 79 of the ceramic heat-discharging member, and light emitting diodes are mounted to the circuit. When heat is generated from the light emitting diodes, the ceramic material converts heat to far infrared radiation in order to pass it through the synthetic resin material 9 and further to discharge the heat. Note that the ceramic heat-discharging member 78 may be configured to a hollow structure and a control device, such as an AC adaptor, may be included in the hollow. The cable 77 is extended to the rear end side of the lighting appliance 401 and connected to the power source (not shown) via a main cable (not shown), a rectifier (not shown) and so on.

As shown in FIG. 10, the synthetic resin material 9 is molded such that the ceramic heat-discharging member 78, light emitting diodes 81 mounted to one end surface 79 of the ceramic heat-discharging member 78, the joint points of the wires 71 to the substrate and the vicinity thereof are sealed off with the synthetic resin material 9 in one united body to thereby form the light illumination member 403.

In the fourth embodiment shown in FIG. 9 and FIG. 10, the light illuminating member 403 is formed in substantially a spherical shape, the ceramic heat-discharging member 78 mounted with light emitting diodes 81 is arranged in the center of the light illuminating member 403, and the wires 71 to be connected to one end surface 79 of the ceramic heat-discharging member 78 working as a substrate are fixed with the synthetic resin material 9 at the connecting points and the vicinity thereof and pass straightly through the inside of the light illuminating member 403 so that it is extended to the power source (not shown) side.

The synthetic resin material 9 is prepared by homogeneously dispersing particulates of highly-diffusible silica to the inside of a silicon resin working as the matrix substance, irrespective of the location across the light illuminating member. Then, light irradiated from the light emitting diodes collides against the particulates 92 of highly-diffusible silica to cause Mie-diffusion. In the fifth embodiment, since the whole periphery of the spherical light illuminating member 403 works as a light illumination member, a light irradiation range of substantially 360 degrees can be secured, and therefore, the use of the lighting appliance according to this embodiment is so advantageous when it is used on a road where construction work has been carried out in view of safety for the pedestrians. Since the synthetic resin material mixed with said highly-diffusible silica has a certain elasticity, it would never be broken or damaged due to shocks imposed from the outside.

Since the composition of the synthetic resin material 9 in this embodiment is the same as that in the first embodiment, an explanation on the detail thereof shall be omitted. Note that the mixing ratio of the matrix substance 91 and particulates 92 of highly-diffusible silica is determined depending on the size and shape of the light illuminating member 403. Generally, the more the size of the light illuminating member 403 increases, the more the ratio of the particulates 92 of highly-diffusible silica decreases, and vice versa.

By configuring the lighting appliance as described above, a lighting appliance 401 with extremely simple configuration can be provided.

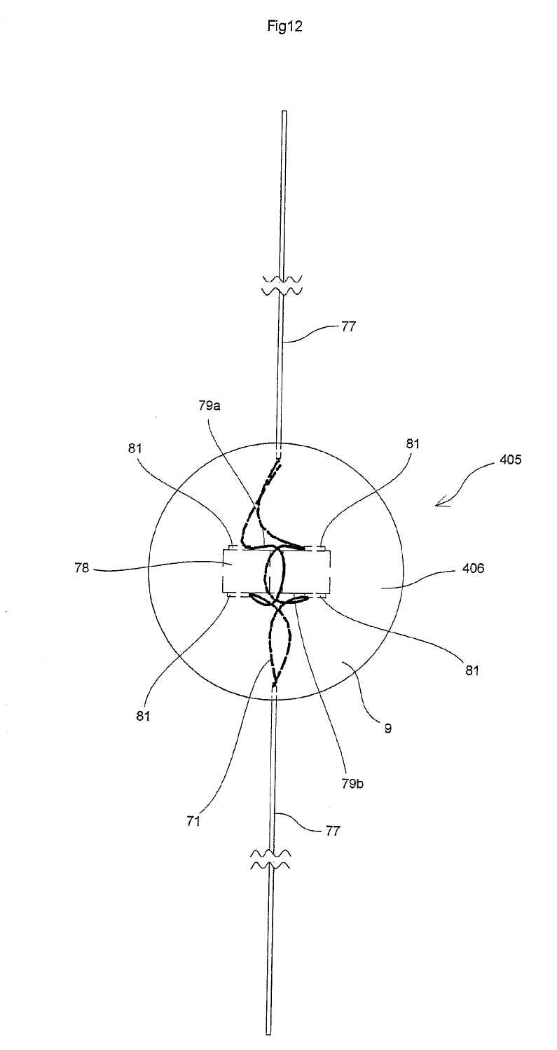

Referring to FIG. 12, a variation 405 of the lighting appliance 401 shown in FIG. 10 is represented. In this lighting appliance 405, light emitting diodes 81 are mounted to both end surfaces 79a, 79b of the ceramic heat-discharging member, wires 71 are connected to the both end surfaces 79a, 79b, and a cable 77 is extended from a position opposite to the light illuminating member 406 formed with a synthetic resin material 9.

By configuring the lighting appliance as described above, it is made possible to connect a plurality of lighting appliances 405 to a cable 77 to thereby provide a lighting appliance 405 which is extremely simple and can be operated continuously.

### Sixth Embodiment

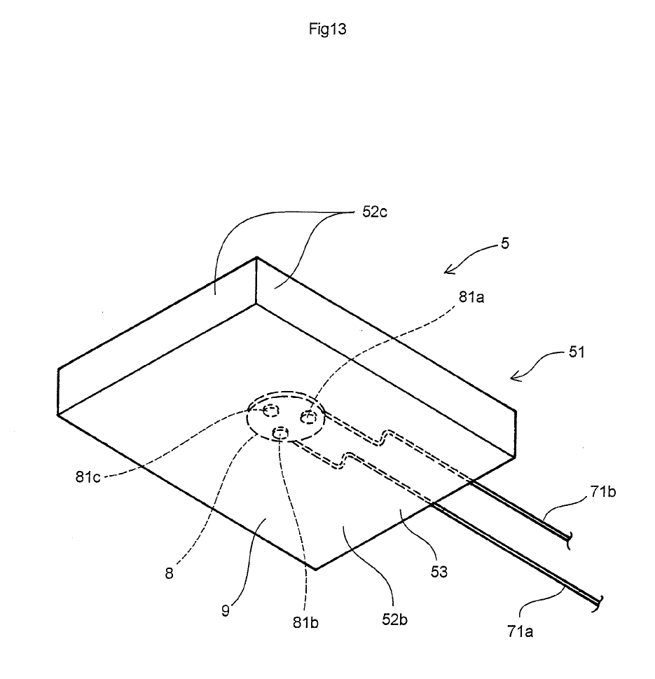

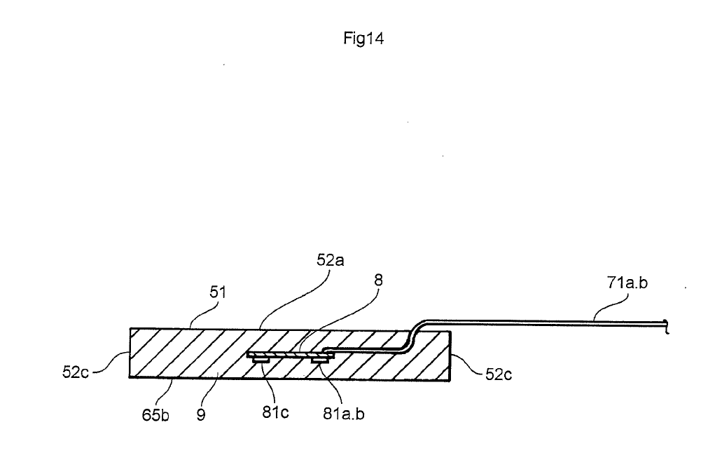

, FIG. 13 and FIG. 14 are a perspective view and a cross-sectional view taken in the vertical direction, respectively, of a lighting appliance of the plate type according to the sixth embodiment of the present invention. In this embodiment as well, the light illuminating member 53 of the lighting appliance main body 51 is formed with a synthetic resin material which is prepared by mixing highly-diffusible silica as a light-diffusion particulates to a light-permeable silicon resin having a certain elasticity, and a substrate 8 mounted with light emitting diodes 81 is sealed off with said synthetic resin material.

In the sixth embodiment, the light illuminating member 53 of the lighting appliance main body 51 is formed in a rectangular plate shape having a thickness using the synthetic resin material 9, and a substrate 8 mounted with light emitting diodes 81a, 82b, 82c is arranged at the center of the light illumination member composed of said synthetic resin material 9. The substrate 8, the joint points of the wires 71a, 71b connected to the substrate 8 and the vicinity thereof are sealed off with the synthetic resin material by molding in one united body and fixed in said resin. However, the wires 71a, 71b are extended from the inside of the synthetic resin material 9 to the surface 52a of the lighting appliance main body 51 (the opposite side to the side where light emitting diodes are mounted) and further connected to a rectifier and the power source (not shown).

In this embodiment, the whole area of the surface 52a, the reverse surface 52b and the lateral surfaces 52c of the light illuminating member 53 of the lighting appliance main body 51 work as a light illuminating member, so that illumination without local unevenness can be obtained. The lighting appliance according to the sixth embodiment can be placed on a road surface or a floor because it is formed in a palate shape, and for example, the whole area of a floor can be made to an illumination structure by bedding the plate-shaped lighting appliance main bodies 51 such that the lateral surfaces 52c thereof joint to each other. Since the synthetic resin material has a certain elasticity, as mentioned in the above-described embodiment, it would never be damaged due to shocks, and pedestrians can walk on the road made by bedding the lighting appliance main bodies. Thus, with the lighting appliance of the invention, a use that is not imaginable in the past can be achieved.

The synthetic resin material 9 is prepared by homogeneously dispersing particulates of highly-diffusible silica to the inside of a silicon resin working as the matrix substance, irrespective of the position across the light illuminating member. Then, light irradiated from the light emitting diodes collides against the particulates 92 of highly-diffusible silica to cause Mie-diffusion. In the sixth embodiment, since the whole periphery of the spherical light illuminating member 53 works as a light illumination member, a light irradiation range of substantially 360 degrees can be secured, and therefore, the use of the lighting appliance according to this embodiment is so advantageous when it is used as a floor material in view of safety for the pedestrians and can be used as an illumination appliance giving an excellent sense of beauty for architectural structures. Since the synthetic resin material mixed with said highly-diffusible silica has a certain elasticity, it would never be broken or damaged due to shocks imposed from the outside.

Since the composition of the synthetic resin material 9 in this embodiment is the same as that in the first embodiment, an explanation on the detail thereof shall be omitted. Note that the mixing ratio of the matrix substance 91 and particulates 92 of highly-diffusible silica is determined depending on the size and shape of the light illuminating member 53. Generally, the more the size of the light illuminating member 53 increases, the more the ratio of the particulates 92 of highly-diffusible silica decreases, and vice versa.

The process for manufacturing the lighting appliances 1 to 5 described above can be achieved easily by carrying out a molding operation, specifically injection molding or extrusion molding, using a synthetic resin material in the state that the substrate 8 mounted with light emitting diodes and connecting wires 71 are placed in a mold. Alternatively, without using a mold for injection molding or extrusion molding, a method wherein a substrate 8 mounted with light emitting diodes 81 and connecting wires 71 are placed in a capsule-shaped mold composed of a synthetic resin material, followed by pouring a synthetic resin material into the mold, and then divide the capsule-shaped mold after the resin had cured may be used for manufacturing the lighting appliance.

Although the synthetic resin material 9 prepared by mixing particulates 92 of highly-diffusible silica to a silicon resin 91, is formed into a lighting appliance main body of the hemispherical, spherical and plate-like types in the first to sixth embodiments, the present invention is not limited to these types. Furthermore, the matrix substance of the synthetic resin material is not limited to a silicon resin, and the other light-permeable synthetic resin materials, including light-permeable thermosetting resins, such as polyester resins, polyurethane resins and epoxy resins, may be used. Even a light-permeable thermoplastic resin having a melting point which is higher than a temperature caused in the substrate may be used.

Further, PET coating to the surface of a light illuminating member of the lighting appliance according to the first to sixth embodiments may be implemented in order to prevent said surface from being spoiled, and said PET resin coating may be peeled off and replaced with a new PET resin coating, when it became dirty. Although the structures of the lighting appliance wherein the lighting appliance main body is formed at the tip end of a cable branched from a main cable is shown, the necessity of the branched cables, the shapes and the number of the cables to be connected are not limited to the examples disclosed above.

Furthermore, the light illuminating member and the cable of the lighting appliance according to the first to sixth embodiments may be made of a material which is resistant to explosive gasses to thereby provide an illumination appliance of the explosion prevention type. Specifically, the surface of the light illuminating member may be coated with a material with anti-explosion property, such as a resin being inactive against explosive gasses, and/or a cable may be covered with a metal by means of die casting to make it anti-explosive.

### Seventh Embodiment

Now, a lighting appliance 6 adapted to be installed to a power source box unit 10, which is attached to the ceiling, etc. of an architectural structure and the like will be explained.

A lighting appliance 6 is fitted to a power source box unit 10 attached to the ceiling, etc. of an architectural structure and the like, and it is a lighting appliance of the convex type that can be used as an alternative of conventional fluorescence lighting appliances.

A light illuminating member 63 constituting a lighting appliance main body 61 of the lighting appliance 6 is formed by molding with a synthetic resin material in the state that the light illuminating member seals off a substrate 8 mounted with light emitting diodes 81 therein, said synthetic resin material is prepared by mixing highly-diffusible silica as a light-diffusing particulates to a silicon resin having a certain elasticity.

In the seventh embodiment, a light illuminating member 63 is formed with a synthetic resin material 9 in a convex shape, in which the central portion of the front end surface of the light illuminating member is made thicker than the else. To the rear end surface of the light illuminating member 63, a plate-shaped body 62 is attached by means of a fixing member 65.

A substrate 8 mounted with light emitting diodes 81 is disposed to the light illuminating member 63 side of the plate-shaped body 62, and the substrate 8 mounted with light emitting diodes is formed by molding using a synthetic resin material 9 and is fixed inside the synthetic resin material in one united body in a contacted state.

An AC adaptor and a rated current engine are protruded in the power source box unit 10 side of the plate-shaped body 62, and a terminal 76 to be fitted to the power source box unit 10 protrudes from a control unit 75, such as an optical sensor unit.

The synthetic resin material 9 is prepared by homogeneously dispersing particulates of highly-diffusible silica 91 to the inside of a silicon resin working as the matrix substance, irrespective of the location across the light illuminating member. Then, light irradiated from the light emitting diodes collides against the highly-diffusible silica 91 to cause Mie-diffusion. In the seventh embodiment, since the whole member of the convex-shaped light illuminating member 63 works as a light illuminating member, a lighting appliance for interior use which can give high illumination can be provided. Since the synthetic resin material mixed with said highly-diffusible silica has a certain elasticity, it would never be broken or damaged due to shocks imposed from the outside.

Since the composition of the synthetic resin material 9 in this embodiment is the same as that in the first embodiment, an explanation on the detail thereof shall be omitted. Note that the mixing ratio of the matrix substance 91 and particulates 92 of highly-diffusible silica is determined depending on the size and shape of the light illuminating member 63. Generally, the more the size of the light illuminating member 63 increases, the more the ratio of the particulates 92 of highly-diffusible silica decreases, and vice versa.

Note that, when a light illuminating member 63 of the large size type is molded, instead of sealing off the substrate mounted with light emitting diodes in the light illuminating member in one united body, a coverture member, which is enveloped with a synthetic resin material 9 and retains a given space between the circumference of the substrate 8 mounted with light emitting diodes 81 and the synthetic resin material, may be formed so that the weight of the light illuminating member 63 can be reduced.

As shown in FIG. 12, the lighting appliance 6 works as a lighting appliance of the ceiling-attached type by inserting a terminal 76 from the lighting appliance 6 to the reception part of a power source box unit 10 disposed to a ceiling, etc. of an architectural structure and the like.

### Eighth Embodiment

Now, an explanation on a variation of the lighting appliance 66 of the type which is disposed to mainly a power source box unit 10 attached to a ceiling, etc. of an architectural structure and the like will be given below.

The lighting appliance 66 is adapted to be engaged with a power source box unit 10 attached to a ceiling, etc. of an architectural structure and the like, and it is a square-shaped and plate-like lighting appliance which can be used as an alternative of conventional lighting appliances.

In this embodiment, the light illuminating member 67 is formed in a plate shape having a given thickness with a synthetic resin material 9. A plate-shaped body 68 is attached to the rear end surface of the light illuminating member by means of a fixing member 69.

A light illuminating member 67 constituting a lighting appliance main body of the lighting appliance 66 is formed by molding with a synthetic resin material 9 in the state that the light illuminating member seals off a substrate 8 mounted with light emitting diodes 81 therein, said synthetic resin material 9 is prepared by mixing highly-diffusible silica as a light-diffusing particulates to a silicon resin having a certain elasticity.

An AC adaptor and a rated current engine are protruded in the power source box unit 10 side of the plate-shaped body 62, and a terminal 76 to be fitted to the power source box unit 10 protrudes from a control unit 75 such as an optical sensor unit.

The synthetic resin material 9 is prepared by homogeneously dispersing particulates of highly-diffusible silica to the inside of a silicon resin working as the matrix substance, irrespective of the location across the light illuminating member. Then, light irradiated from the light emitting diodes collides against the highly-diffusible silica 92 to cause Mie-diffusion. In the eighth embodiment, since the whole member of the plate-shaped light illuminating member 67 works as a light illuminating member, a lighting appliance for interior use which can give high illumination can be provided. Since the synthetic resin material mixed with said highly-diffusible silica has a certain elasticity, it would never be broken or damaged due to shocks imposed from the outside.

Since the composition of the synthetic resin material 9 in this embodiment is the same as that in the first embodiment, an explanation on the detail thereof shall be omitted. Note that the mixing ratio of the matrix substance 91 and particulates 92 of highly-diffusible silica is determined depending on the size and shape of the light illuminating member 67. Generally, the more the size of the light illuminating member 67 increases, the more the ratio of the particulates 92 of highly-diffusible silica decreases, and vice versa.

Note that, when a light illuminating member 67 of the large size type is molded, instead of sealing off the substrate mounted with light emitting diodes in one united body therein, a coverture member, which is enveloped with a synthetic resin material 9 and retains a given space between the circumference of the substrate 8 mounted with light emitting diodes 81 and the synthetic resin material 9, may be formed so that the weight of the light illuminating member 67 can be reduced.

As shown in FIG. 12, the lighting appliance 66 works as a lighting appliance of the ceiling-attached type by inserting a terminal 76 from the lighting appliance 66 to the reception part of a power source box unit 10 disposed to a ceiling, etc. of an architectural structure and the like.

The process for manufacturing the lighting appliances 6, 66 of the ceiling-attached type can be achieved easily by carrying out a molding operation using a synthetic resin material, specifically injection molding or extrusion molding, in the state that the substrate 8 mounted with light emitting diodes and connecting wires 71 are placed in a mold.

Alternatively, without using a mold for injection molding or extrusion molding, a method wherein a substrate 8 mounted with light emitting diodes 81 and connecting wires 71 are placed in a bowl-shaped or measure-shaped mold composed of a synthetic resin material, followed by pouring a synthetic resin material into a mold, and then divide said mold may be used for manufacturing the lighting appliance. Besides, when the light illuminating member is formed as a coverture member, in which the substrate 8 and light emitting diodes are received, instead of sealing off said substrate and said light emitting diodes, various parts may be simply attached to said coverture member after pouring a synthetic resin material 9 into a mold.

In the seventh and eighth embodiments, although a synthetic resin material prepared by mixing highly-diffusible silica to a silicon resin is used to manufacture the convex-shaped and/or a plate-shaped lighting appliance main body, the present invention is not limited to those shapes, and the matrix substance of the synthetic resin material is not limited to a silicon resin as well. Therefore, the matrix substance may be the other light-permeable synthetic resins including thermosetting resins, such as polyester resins, polyurethane resins and epoxy resins, and even a light-permeable thermoplastic resin, the melting point of which is higher than a temperature of the heat appeared in the substrate, etc. may be used.

Further, PET coating to the surface of a light illuminating member of the lighting appliance according to the seventh and eighth embodiments may be implemented in order to prevent said surface from being spoiled, and said PET resin coating may be peeled off and replaced with a new PET resin coating, when it became dirty.

The lighting appliances according to the above-described embodiments of the present invention gives light of milky color from the whole periphery of the light illuminating member, because the light illuminating member is formed by sealing off light emitting diodes therein with a synthetic resin material to which light-diffusing particulates capable of causing Mie-diffusion are mixed, and it is a lighting appliance provided with excellent properties of light directivity and light diffusion.

The lighting appliance according to the present invention can be provided as a lighting appliance having an excellent properties of light directivity and light diffusion, because of that light emitting diodes are mounted to a substrate and are then sealed off together with the substrate in the light illuminating member using a synthetic resin material to which light-diffusing particulates capable of diffusing light irradiated from the light emitting diodes are mixed.

### DESCRIPTION OF THE REFERENCE NUMERALS

1 Lighting appliance
11 Lighting appliance main body
12 Light illuminating member front end surface
13 Light illuminating member
14 Setting
15 Connecting tube
16 Heat-discharging plate
161 Heat-discharging pore
17 Reinforcing cylinder
2 Lighting appliance
21 Lighting appliance main body
23 Light illuminating member
24 Heat-discharging member
25 Heat-discharging member front end surface
26 Heat-discharging member rear end surface
28 Hollow section
29 Reinforcing cylinder
3 Lighting appliance
31 Lighting appliance main body
33 Light illuminating member
34 Ceramic heat-discharging plate
35 Aluminum bottom plate
36 Aluminum conductive tube
37 Reinforce section
4 Lighting appliance
41 Lighting appliance main body
43 Light illuminating member
46 Ceramic heat-discharging rod
47 Ceramic tube
48 Heat-conductive bar
49 Setting
5 Lighting appliance
51 Lighting appliance main body
52a Light illuminating member, Surface
52b Light illuminating member, Back surface
52c Light illuminating member, Lateral surface
53 Light illuminating member
6 Lighting appliance
61 Lighting appliance main body
62 Plate-shaped body
63 Light illuminating member
64 Light illuminating member front end surface
65 Fixing part
66 Lighting appliance
67 Light illuminating member
68 Plate-shaped body
69 Fixing part
7 Cable
71 Wire
72 Insulating member
73 Wire connection point
74 Control unit
75 Control unit
76 Plate
77 Cable
8 Substrate
81 Light emitting diode (LED)
9 Synthetic resin material
91 Matrix
92 Particulates
10 Power source box unit

1. A lighting appliance characterized by including a light illuminating member which seals off a substrate mounted with light emitting diodes in the light illuminating member and is formed with a synthetic resin material to which light-diffusing particulates capable of diffusing light irradiated from the light emitting diodes are included.

2. A lighting appliance according to claim 1,
wherein the synthetic resin material to seal off the light emitting diodes is prepared by mixing particulates with a particle size that causes Mie-diffusion against light irradiated from the light emitting diodes to a light-permeable synthetic resin matrix substance.

3. A lighting appliance according to claim 2,
wherein the synthetic resin material to seal off the light emitting diodes is prepared by mixing particulates of silicon dioxide to a light-permeable synthetic resin matrix substance.

4. A lighting appliance according to claim 1,
wherein the synthetic resin material to seal off the light emitting diodes is a synthetic resin material prepared by mixing agglomerates of silicon dioxide particulates prepared by agglomerating and binding while melting the particulates of silicon dioxide to a light-permeable synthetic resin matrix substance.

5. A lighting appliance according to claim 4,
wherein the particulate of silicon dioxide is a spherical particle having a diameter of from 10 to 30 nm and the agglomerate of the particulates of the highly-diffusible silica is a bulky agglomerate having a diameter of from 100 to 400 nm, which is formed as a result of agglomeration of plural particulates.

6. A lighting appliance according to claim 1,
wherein the light-permeable synthetic resin matrix substance of the synthetic resin material is a light-permeable silicon resin.

7. A lighting appliance according to claim 1,
wherein wires are connected to a substrate mounted with light emitting diodes, and the wires, the substrate and the light emitting diodes are sealed off in one united body with a synthetic resin material prepared by mixing particulates capable of causing diffusion of light irradiated from the light emitting diodes to thereby form a light illuminating member.

8. A lighting appliance according to claim 1,
wherein a heat-discharging member is attached to the substrate.

9. A lighting appliance according to claim 8,
wherein the heat-discharging member is formed with any of a heat-conductive synthetic resin and/or a metal member and/or a heat-discharging ceramic.

10. A lighting appliance according to claim 1,
wherein the light illuminating member is formed in spherical, hemispherical, plate-like, lens-like or polygonal shape.

11. A lighting appliance according to claim 1,
wherein at least the surface of the light illuminating member and the cable extended from the light illuminating member are formed with a material inactive to explosive gasses so that the lighting appliance can be a lighting appliance, the use of which is allowed in an explosion prevention area.

12. A process for manufacturing a lighting appliance characterized in that a substrate mounted with light emitting diodes is connected with wires, the substrate mounted with light emitting diodes is placed in a mold, and the wires, the substrate and the light emitting diodes are sealed off in one united body by molding with a synthetic resin material mixed with particulates capable of diffusing light irradiated from the light emitting diodes to thereby form a light illuminating member.

13. A process for manufacturing a lighting appliance according to claim 12,
wherein a substrate mounted with light emitting diodes is connected with wires, the substrate mounted with light emitting diodes and a heat-discharging member are placed in a mold, and the wires, the substrate, the light emitting diodes and the heat-discharging member are sealed off in one united body by molding with a synthetic resin material mixed with particulates capable of diffusing light irradiated from the light emitting diodes to thereby form a light illuminating member.

14. A lighting appliance according to claim 2,
wherein the synthetic resin material to seal off the light emitting diodes is a synthetic resin material prepared by mixing agglomerates of silicon dioxide particulates prepared by agglomerating and binding while melting the particulates of silicon dioxide to a light-permeable synthetic resin matrix substance.

15. A lighting appliance according to claim 3,
wherein the synthetic resin material to seal off the light emitting diodes is a synthetic resin material prepared by mixing agglomerates of silicon dioxide particulates prepared by agglomerating and binding while melting the particulates of silicon dioxide to a light-permeable synthetic resin matrix substance.

16. A lighting appliance according to claim 14,
wherein the particulate of silicon dioxide is a spherical particle having a diameter of from 10 to 30 nm and the agglomerate of the particulates of the highly-diffusible silica is a bulky agglomerate having a diameter of from 100 to 400 nm, which is formed as a result of agglomeration of plural particulates.

17. A lighting appliance according to claim 15,
wherein the particulate of silicon dioxide is a spherical particle having a diameter of from 10 to 30 nm and the agglomerate of the particulates of the highly-diffusible silica is a bulky agglomerate having a diameter of from 100 to 400 nm, which is formed as a result of agglomeration of plural particulates.

18. A lighting appliance according to claim 2,
wherein the light-permeable synthetic resin matrix substance of the synthetic resin material is a light-permeable silicon resin.

19. A lighting appliance according to claim 3,
wherein the light-permeable synthetic resin matrix substance of the synthetic resin material is a light-permeable silicon resin.

20. A lighting appliance according to claim 4,
wherein the light-permeable synthetic resin matrix substance of the synthetic resin material is a light-permeable silicon resin.
